(19) United States
(12) Patent Application Publication
(10) Pub. No.: US 2006/0047964 A1
(43) Pub. Date: Mar. 2, 2006

(54) Data server, print data distribution method, print data distribution program and network printing system

(75) Inventor: Kazumi Murata, Yokohama-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/929,821

(22) Filed: Aug. 30, 2004

(51) Int. Cl. H04L 9/00

(52) U.S. Cl. 713/176

(57) ABSTRACT

An object of the present invention is to make a difference between display data to be displayed on a destination terminal and print data, thereby preventing a data falsification from being performed.

A network printing system includes a data server 10 connected to a plurality of terminals (21 to 23) via a network and a printing system 40 connected to the network. When receiving, from a source terminal, print data, an address to be used for data transfer to a destination terminal, and Input of a watermark to be added at the time of data transfer to the destination terminal, the data server 10 creates display data corresponding to the print data by adding the watermark to the print data, sends a data URL to a destination terminal whose address has been input, thereby performing distribution processing to the destination terminal and distribution of the print data to which the watermark has been added in response to a printing request for the printing system.

### BACKGROUND OF THE INVENTION

1. Field of the Invention

The present invention relates to a network printing system including a data server connected to a plurality of terminals via a network and a printing system connected to the network and distributing print data to the terminals for print output, and the data server, a print data distribution method and a print data distribution program used in the network printing system.

2. Description of the Related Art

There has been available a document distribution/output system that sequentially transforms to-be-distributed application-dependent document data transmitted from a source terminal into intermediate language document data and web-browser-displayable document data and holds the transformed document data, notifies a destination terminal of a URL (Uniform Resource Locator) corresponding to the web-browser-displayable document data by means of e-mail, and controls printing of the document data with a printer connected to a network. This prior art is disclosed, for example, in Jpn. Pat. Appln. Laid-Open Publication No. 2003-141021 (Abstract, FIG. 1).

However, there lies a problem in the abovementioned document distribution/output system that there is no difference between the web-browser-displayable document data and data to be printed out. Therefore, when the URL is transmitted to a plurality of the destination terminals under the condition that there is no difference between them, there is a possibility that it becomes impossible to identify the original document data due to a data falsification or the like.

### SUMMARY OF THE INVENTION

The present invention has been made in view of the above point, and an object thereof is to provide a network printing system capable of making a difference between data to be displayed on a destination terminal and data to be printed out to prevent a data falsification from being performed and a data server, a print data distribution method and a print data distribution program used in the network printing system.

To solve the above problem, according to a first aspect of the present invention, there is provided a data server that can be connected to terminals including a printing system via a network, comprising: a data reception section that receives print data and falsification-proof data from a source terminal; a data creation section that creates display data by adding the falsification-proof data to the print data; and a distribution processing section that sends an address indicating the display data to a destination terminal whose address has been input as well as distributes the print data in response to a printing request for the printing system.

According to a second aspect of the present invention, there is provided a data server that can be connected to terminals including a printing system via a network, comprising: a data reception section that receives print data and falsification-proof data from a source terminal; a data creation section that creates display data by adding the falsification-proof data to the print data; and a distribution processing section that sends an address indicating the display data to a destination terminal whose address has been input as well as distributes the print data in response to a printing request for the printing system.

According to a third aspect of the present invention, there is provided a print data distribution method performed in a data server that can be connected to terminals including a printing system via a network, comprising: a reception step of receiving print data and falsification-proof data from a source terminal; a data creation step of creating display data by adding the falsification-proof data to the print data; and a distribution processing step of sending an address indicating the display data to a destination terminal as well as distributing the print data in response to a printing request for the printing system.

According to a fourth aspect of the present invention, there is provided a print data distribution program executed by a computer in a data server that is connected to terminals including a printing system via a network, the program allowing the computer to execute: a reception step of receiving print data and falsification-proof data from a source terminal; a data creation step of creating display data by adding the falsification-proof data to the print data; and a distribution processing step of sending an address indicating the display data to a destination terminal as well as distributing the print data in response to a printing request for the printing system.

According to a fifth aspect of the present invention, there is provided a network printing system comprising: a printing system; and a data server that can be connected to terminals including a printing system via a network, comprising: a data reception section that receives print data and falsification-proof data from a source terminal; a data creation section that creates display data by adding the falsification-proof data to the print data; and a distribution processing section that sends an address indicating the display data to a destination terminal whose address has been input as well as distributes the print data in response to a printing request for the printing system.

According to a sixth aspect of the present invention, there is provided a network printing system comprising: a printing system; and a data server that can be connected to terminals including a printing system via a network, comprising: a data reception section that receives print data and falsification-proof data from a source terminal; a data creation section that creates display data by adding the falsification-proof data to the print data; and a distribution processing section that sends an address indicating the display data to a destination terminal whose address has been input as well as distributes the print data in response to a printing request for the printing system.

### DESCRIPTION OF THE DRAWINGS

FIG. 1 is a block diagram showing a configuration of a network printing system according to an embodiment of the present invention;

FIG. 2 is a block diagram showing a configuration of a printing system 40 connected to an Internet 30 shown in FIG. 1;

FIG. 3 is an operational flowchart to explain data transfer from a client PC 21 as a source terminal shown in FIG. 1 to a data server 10;

FIGS. 4A, 4B and 4C are views to explain a shifting window that shits with input operations or the like in the operational flowchart of FIG. 3;

FIG. 5 is a flowchart to explain an operation of the data server 10 at the time when data is transferred thereto from the client PC 21 of FIG. 1 as a source terminal;

FIG. 6 is a flowchart to explain a creation of display data and print data in the data server 10 of FIG. 1; and

FIG. 7 is a flowchart to explain an operation of the data server 10 performed in response to a printing request from the printing system 40 of FIG. 2.

### DESCRIPTION OF THE EMBODIMENTS

An embodiment of the present invention will be described below with reference to the accompanying drawings.

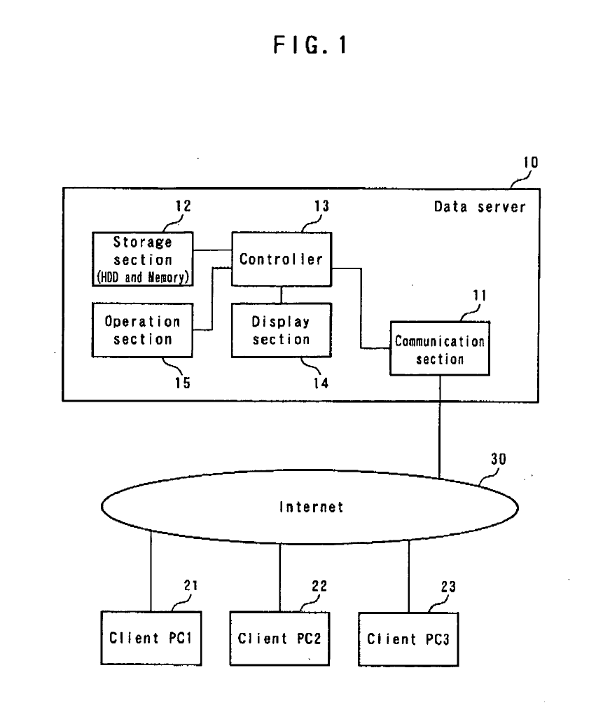

FIG. 1 is a block diagram showing a configuration of a network printing system according to an embodiment of the present Invention. In the network printing system shown in FIG. 1, a data server 10 serving as a server for the printing system is connected to client PCs 21 to 23 as web-browser-enabled terminals via an Internet 30 as a communication network.

The data server 10 includes: a communication section (data reception section) 11 that connects to the Internet 30 and exchanging data; a storage section 12 that stores data received from the client PCs 21 to 23; a controller (distribution processing section) 13 that processes data stored in the storage section 12, creates and distributes display data to which a watermark serving as falsification-proof data is added or printer-printable data; a display section 14 that displays a processing result of the server; and an operation section 15 for a user to perform input operations.

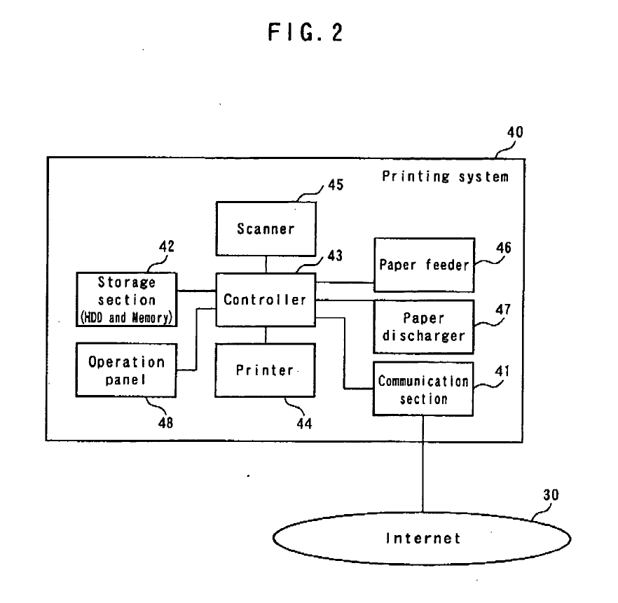

FIG. 2 is a block diagram showing a configuration of a printing system 40 connected to the Internet 30 shown in FIG. 1. The printing system 40, shown in FIG. 2 includes: a communication section 41 that exchanges data with the data server 10; a storage section 42 that stores image-processed data; a controller 43 that mainly processes data stored in the storage section 42; a printer 44 that performs printing; a scanner 45 that scans image data; a paper feeder 46 that feeds a paper to the inside of the system; a paper discharger 47 that discharges a printed paper; and an operation panel 48 that receives input operations and performs a display operation.

An operation of the network printing system having the above configuration will next be described below.

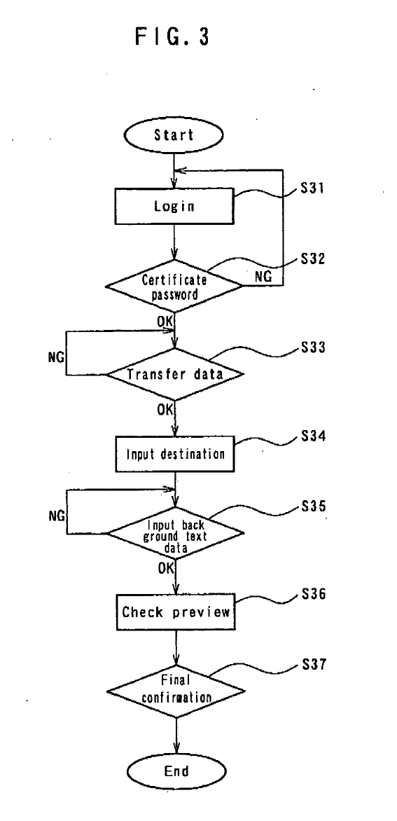

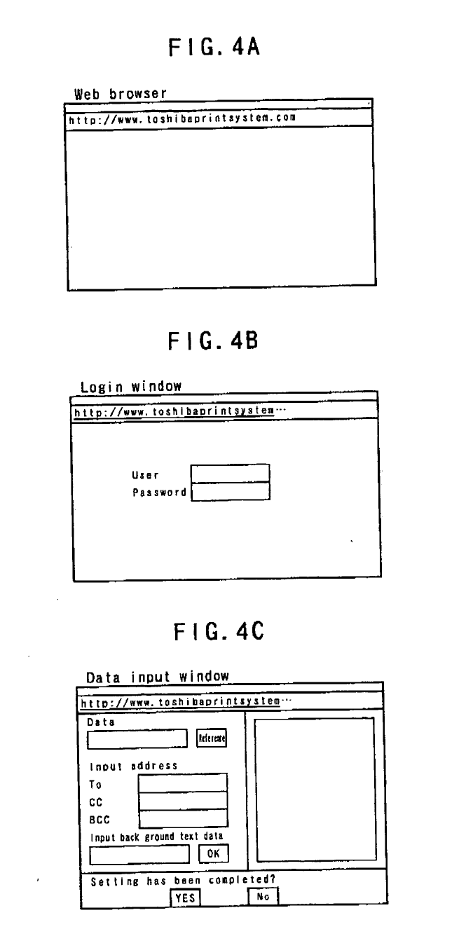

Firstly, a description will be given of a data transfer operation from the client PC 21 as a source terminal to the data server 10 with reference to an operational flowchart of FIG. 3 and a shifting window of FIGS. 4A to 4C that shifts with input operations or the like. The client PC 21 connects to the data server 10. That is, an hp input is made by addressing on the web browser or the like of FIG. 4A, and the client PC 21 logs in (step S31). After a login window shown in FIG. 4B has been displayed, a user name and password are input for password authentication to be provided by the data server 10 (step S32). When the password is authenticated, the client PC 21 prompts a user to input transfer data to be printed out, the address of a destination terminal for data transfer, and background text data serving as the watermark to be added to display data to the data input window shown in FIG. 4C (steps S33 to S35). After that, the client PC 21 allows the user to check a preview window (step 536), and the user performs a final confirmation of the display data, the address of a destination terminal or the like (step S37).

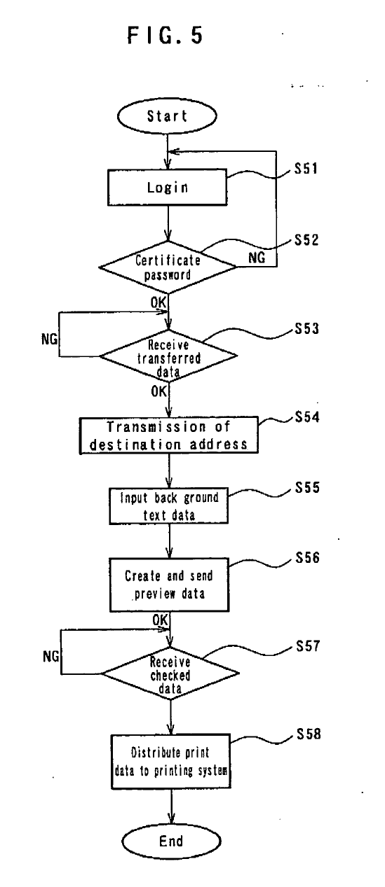

Next, a description will be given of an operation of the data server 10 at the time when data is transferred thereto from the client PC 21 as a source terminal with reference to the flowchart of FIG. 5. The data server 10 receives login request from the client PC 21 and authenticates the client PC 21 as one user based on the password or the like (steps S51 and S52). After that, the data server 10 receives transfer data to be printed out in the printing system 40 from the client PC 21 together with the address of the destination terminal and stores the data (transfer data) to be printed out and the address of the destination terminal in the storage section 12 (OK in step S53 (reception step)).

The data server 10 then performs processing for data distribution to the destination terminal address stored in the storage section 12 (step S54). The destination terminal address to be input includes, as shown in FIG. 4C, “To”, “CC”, BCC” or the like for determination of distribution order.

The data server 10 then receives an input of the background text data serving as the watermark to be added to the print data transmitted from the client PC 21 (step S55), creates preview data of the print data to which the watermark has been added, and sends the created preview data to the client PC 21 (step S56 (data creation step)).

As to the background text data, duplication of the data to which the background text data (watermark) is added and the data to which the back ground text data is not added is made for the print data (application string data) to be sent to the printing system 40. The watermark added data is created as the display data to be displayed in the web format. The watermark added display data is transmitted to the source terminal as a preview for user confirmation.

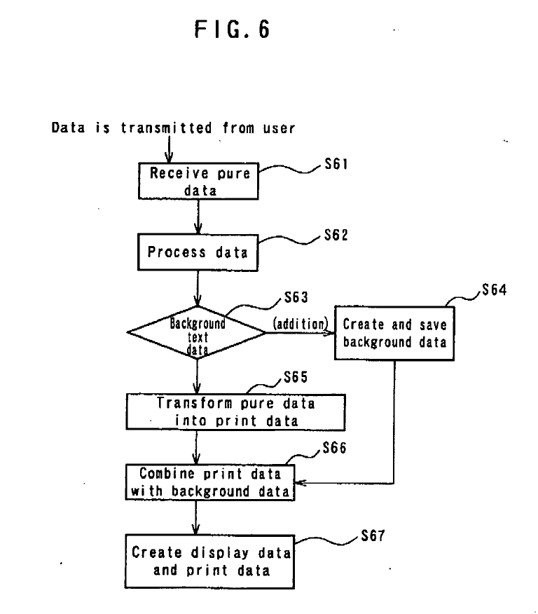

Further, a detailed description will be given of the processing of the back ground text data performed in the data server 10 with reference to a flowchart of FIG. 6, according to which the display and print data are created. Firstly, the data server 10 receives a transmission from the source user, that is, receives pure data for printing from the client PC 21 and processes the received data (steps S61 and S62). When having received an input of background text data as a watermark, the data server 10 creates background data as additional processing and stores the created data in the storage section 12 (steps S63 and S64). Next, the data server 10 transforms the pure data transmitted from the source user into print data so as to allow the transmitted data to be printed out by the printing system 40 (step S65), and combines the transformed print data with the created background data (step S66) to create display data (data for web display) (step S67). In this case, the print data that is not combined with the background data is sent to the printing system as print data.

Referring back to FIG. 5, when pressing of OK button has been confirmed after the source user has checked the preview data, the data server 10 receives a final confirmation from the client PC 21 (OK in step S57). Upon receiving the final confirmation, the data server 10 sends a data URL (address) according to a predetermined distribution order to a destination address as well as distributes print data to the printing system 40 to respond to a printing request (step S58 (distribution processing step)).

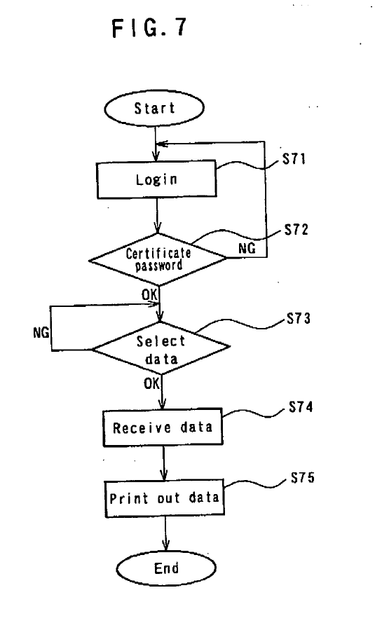

Next, a description will be given of an operation of the data server 10 for the printing request from the printing system 40 with reference to a flowchart of FIG. 7. The data server 10 receives login request from the printing system 40 and authenticates the printing system 40 as one user based on the password or the like (steps S71 and S72). At this time, the data server 10 displays data to be printed out to allow the printing system 40 to select target data among them (OK in step S73). After the data selection, the data server 10 distributes the selected print data to the printing system 40 (step S74) to allow the printing system 40 to print out the distributed data (step S75). Unlike the display data, the data to which the background text data (watermark) has not been added is send to the printing system 40 as the print data.

As described above, according to the above embodiment, it is possible to make a difference between data for web display and print data by creating the display data to be displayed on a destination terminal by adding a watermark to the print data, thereby preventing a data falsification from being performed. In the above embodiment, functions that execute the programs shown in the flowcharts are previously stored in the system. Alternatively, however, the same function may be downloaded from a network to the system or may be installed from a recording medium that stores the function. In this case, any recording medium, such as an ROM, can be used as long as it can store a program and it is readable by the system. The function previously obtained by download or installation may work in collaboration with an OS (Operating System) or the like of the system.

As is clear from the above embodiment, according to the present invention, by distributing print data to which falsification-proof data such as a watermark has been added to the printing system which has received a printing request, it is possible to make a difference between data for web display to be displayed on a destination terminal and the print data, thereby preventing a data falsification from being performed.

What is claimed is:

1. A data server that can be connected to terminals including a printing system via a network, comprising:
a data reception section that receives print data and falsification-proof data from a source terminal;
a data creation section that creates display data by adding the falsification-proof data to the print data; and
a distribution processing section that sends an address indicating the display data to a destination terminal whose address has been input, as well as distributes the print data in response to a printing request for the printing system.

2. The data server according to claim 1, wherein the falsificatlon-proof data is a watermark.

3. A data server that can be connected to terminals including a printing system via a network, comprising:
a data reception section that receives print data and falsification-proof data from a source terminal;
a data creation section that creates display data by adding the falsification-proof data to the print data; and
a distribution processing section that sends an address indicating the display data to a destination terminal whose address has been input as well as distributes the print data in response to a printing request for the printing system.

4. A print data distribution method performed in a data server that can be connected to terminals including a printing system via a network, comprising:
a reception step of receiving print data and falsificatlon-proof data from a source terminal;
a data creation step of creating display data by adding the falsification-proof data to the print data; and
a distribution processing step of sending an address indicating the display data to a destination terminal as well as distributing the print data in response to a printing request for the printing system.

5. A print data distribution program executed by a computer in a data server that is connected to terminals including a printing system via a network, the program allowing the computer to execute;
a reception step of receiving print data and falsification-proof data from a source terminal;
a data creation step of creating display data by adding the falsification-proof data to the print data; and
a distribution processing step of sending an address indicating the display data to a destination terminal as well as distributing the print data in response to a printing request for the printing system.

6. A network printing system comprising:
a printing system; and
a data server that can be connected to terminals including a printing system via a network, comprising: a data reception section that receives print data and falsification-proof data from a source terminal; a data creation section that creates display data by adding the falsification-proof data to the print data; and a distribution processing section that sends an address indicating the display data to a destination terminal whose address has been input as well as distributes the print data in response to a printing request for the printing system.

7. A network printing system comprising:
a printing system; and
a data server that can be connected to terminals including a printing system via a network, comprising: a data reception section that receives print data and falsification-proof data from a source terminal; a data creation section that creates display data by adding the falsification-proof data to the print data; and a distribution processing section that sends an address indicating the display data to a destination terminal whose address has been input as well as distributes the print data in response to a printing request for the printing system.
